(19) United States
(12) Patent Application Publication
(10) Pub. No.: US 2015/0068037 A1
(43) Pub. Date: Mar. 12, 2015

(54) Thermal System Including an Environmental Test Chamber

(71) Applicant: SPX Corporation, Charlotte, NC (US)

(72) Inventor: Richard M. Powell, Linden, PA (US)

(73) Assignee: SPX Corporation, Charlotte, NC (US)

(21) Appl. No.: 14/020,018

(22) Filed: Sep. 6, 2013

(51) Int. Cl. F25B 7/00; B23P 15/26

(52) U.S. Cl. CPC F25B 7/00; B23P 15/26
USPC 29/890.035; 62/440

(57) ABSTRACT

A system is provided where the system includes a chamber, a first cooling system including a first cooling load evaporator, wherein the first cooling system is placed within the chamber, a second cooling system including a fluid coil, wherein the fluid coil is placed within the chamber, and a thermal storage for a second cooling fluid in the second cooling system, wherein the thermal storage is placed outside the chamber. In the system, the first cooling system further includes a first compressor and a first condenser and the second cooling system further includes a thermal storage chiller, wherein the thermal storage chiller is placed outside the chamber.

The invention relates to a thermal system including an environmental test chamber, and more particularly, to a thermal system including an environmental test chamber equipped with a plurality of cooling systems and a method for manufacturing the system.

### BACKGROUND OF THE INVENTION

An environmental test chamber is typically equipped with a single refrigeration system to accommodate various test conditions. Because the test conditions impose large temperature changes in short periods of time, the test chamber contains a large capacity refrigeration system that is capable of imposing a temperature change from 150° C. to −65° C. As the capacity becomes larger, the refrigeration system can accommodate larger temperature changes but requires more energy consumption. The test chamber is operated in various temperature ranges. Simply increasing the capacity of the single refrigeration system may cause unnecessary energy consumption. In addition, a single refrigeration system does not adequately respond to a fast temperature change. For example, when a large amount of heat is dissipated in the test chamber in a short amount of time, the single refrigeration system can be quickly overpowered.

Therefore, there is a need for improved environmental test chamber to address the issues that a single large refrigeration system imposes.

### BRIEF SUMMARY OF THE INVENTION

In one embodiment, a system is provided. The system includes a chamber, a first cooling system including a first cooling load evaporator, wherein the first cooling system is placed within the chamber, a second cooling system including a fluid coil, wherein the fluid coil is placed within the chamber, and a thermal storage for a second cooling fluid in the second cooling system, wherein the thermal storage is placed outside the chamber. In the system, the first cooling system further includes a first compressor and a first condenser, and the second cooling system further includes a thermal storage chiller, wherein the thermal storage chiller is placed outside the chamber. The first cooling system may include a single compressor.

In another aspect, the first cooling system further includes a low stage loop including a low stage compressor and the first cooling load evaporator, a high stage loop including a high stage condenser and a high stage compressor, and a cascade condenser, wherein the low stage loop is configured to process a low stage working fluid and the high stage loop is configured to process a high stage working fluid, wherein the low stage loop and the high stage loop are connected to the cascade condenser, and wherein the system is configured to process the low stage working fluid, the high stage working fluid, and the second working fluid separately from each other within the system.

In another aspect, the system further includes one or more valves, wherein the valves are configured to adjust an amount of the second working fluid flowing into the fluid coil in the second cooling system. In some aspects, the system further includes one or more valves, wherein the valves are configured to adjust amounts of the low stage working fluid, the high stage working fluid and the second working fluid flowing in the system, respectively.

In another aspect, the system further includes one or more expansion devices and a controller, wherein the controller is configured to control the first cooling system and the second cooling system, wherein the controller is configured to activate the second cooling system when the first cooling system is being operated at full capacity, wherein the controller is further configured to activate the second cooling system when a cooling rate of the chamber is less than a target cooling rate, wherein power of the second cooling system is equal to or less than power of the first cooling system, and wherein the second cooling system further includes a brine pump.

In another embodiment, a method for manufacturing a system is provided. The method includes preparing a first cooling system including a low stage loop, a high stage loop, and a cascade condenser, placing the first cooling system inside a test chamber; connecting the low stage loop to the cascade condenser, connecting the high stage loop to the cascade condenser, preparing a second cooling system including a fluid coil, a thermal storage to store the second working fluid, and a thermal storage chiller, placing the fluid coil inside the test chamber, placing the thermal storage outside the test chamber; and placing the thermal storage chiller outside the test chamber.

In another aspect, the method further includes configuring the second cooling system to process the second working fluid in the second cooling system separate from the first cooling system, connecting a controller to the first cooling system, connecting the controller to the second cooling system, configuring the controller to activate the second cooling system when a cooling rate of the test chamber is less than a target cooling rate, preparing a low stage working fluid for the low stage loop, preparing a high stage working fluid for the high stage loop, and configuring the first cooling system to separately flow the low stage working fluid and the high stage working fluid from the second working fluid.

In another embodiment, an apparatus is provided. The apparatus includes a chamber, means for evaporating a first cooling medium, wherein the means for evaporating the first cooling medium is placed inside the chamber; means for evaporating a second cooling medium, wherein the means for evaporating the second cooling medium is placed inside the chamber; means for storing the second cooling medium, wherein the means for storing the second cooling medium is placed outside the chamber, and wherein the second cooling medium separately flows from the first cooling medium within the apparatus.

There has thus been outlined, rather broadly, certain aspects of the invention in order that the detailed description thereof herein may be better understood, and in order that the present contribution to the art may be better appreciated. There are, of course, additional aspects of the invention that will be described below and which will form the subject matter of the claims appended hereto.

In this respect, before explaining at least one aspect of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

### BRIEF DESCRIPTION OF THE DRAWINGS

FIG. 1 is a schematic diagram showing an exemplary thermal system including a test chamber according to the disclosure.

FIG. 2 is a schematic diagram showing another exemplary thermal system including a test chamber according to the disclosure.

FIG. 3 is a schematic diagram showing another exemplary-thermal system including the test chamber according to the disclosure.

FIG. 4 is a schematic chart showing exemplary operation steps of the controller.

FIG. 5 is another schematic chart showing exemplary operation steps of the controller.

### DETAILED DESCRIPTION OF THE INVENTION

An aspect of the disclosure is directed to a thermal system including a first cooling system, a second cooling system and a test chamber, wherein the test chamber includes a first cooling system and is connected to the second cooling system.

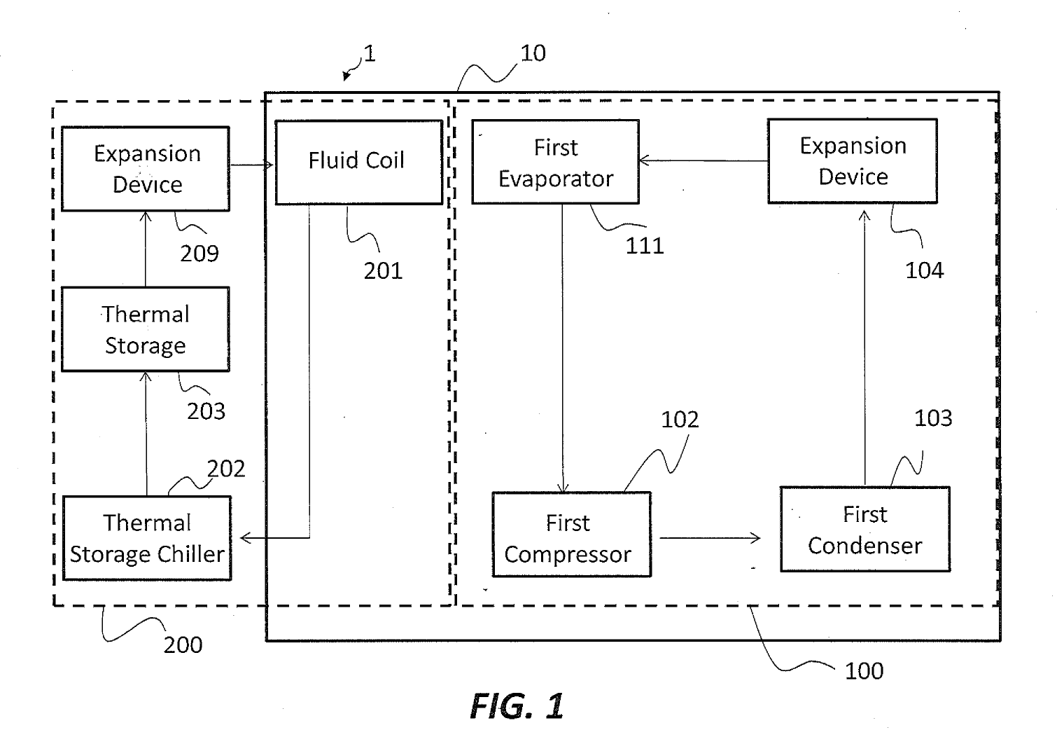

FIG. 1 is a schematic diagram showing an exemplary thermal system including a test chamber according to the disclosure. In particular, FIG. 1 is a schematic diagram showing an exemplary thermal system 1 including a test chamber 10 according to the disclosure. The test chamber 10 may include a first cooling system 100. In addition, the test chamber 10 may be connected to a second cooling system 200.

The first cooling system 100 may include a first cooling load evaporator 111, an expansion device 104, a first compressor 102 and a first condenser 103. The first cooling system 100 may process a first working fluid when the first working fluid enters the first cooling load evaporator 111. The first working fluid may be evaporated in the first cooling load evaporator 111 to form a first working vapor by absorbing heat from the ambient air.

The first working vapor may exit the first cooling load evaporator 111 and enter the first compressor 102, The first compressor 102 may compress the first working vapor, thereby increasing the pressure and the temperature of the first working vapor. The compressed first working vapor may exit the first compressor 102 and then circulate to the first condenser 103. The compression of the first working vapor may be through a single compressor.

While traveling through the first condenser 103, heat may flow out of the first working vapor, thereby cooling the first working vapor. The first working vapor may be condensed and liquefied. The first working fluid may exit the first condenser 103 and then circulate to the first expansion device 104. The first expansion device 104 may substantially reduce the pressure and the temperature of the first working fluid that may circulate through the first cooling system 100, The first working fluid exiting the first expansion device 104 may circulate to the first cooling load evaporator 111.

The second cooling system 200 may include a fluid coil 201, a thermal storage 203, and a thermal storage chiller 202. In one aspect, the thermal storage 203 may be placed outside the test chamber 10. In some aspects, the thermal storage 203 and the thermal storage chiller 202 may be placed outside the test chamber 10. In various aspects, the fluid coil 201 may be placed inside the test chamber 10.

The second working fluid from the thermal storage 203 may enter a second expansion device 209. The second expansion device 209 may substantially reduce the pressure and the temperature of the second working fluid that may circulate through the second cooling system 200, The second working fluid exiting the second expansion device 209 may circulate to the fluid coil 201.

In the fluid coil 201, the temperature of the second working fluid may increase by absorbing heat from the ambient air while traveling through the fluid coil 201. The heated second working fluid or vapor may circulate to the thermal storage chiller 202.

In one aspect, the thermal storage chiller 202 may be placed outside the test chamber 10. The second working fluid may be condensed and cooled and/or liquefied while traveling through the thermal storage chiller 202.

The cooled second working fluid exiting the thermal storage chiller 202 may enter the thermal storage 203. In one aspect, the thermal storage 203 may be placed outside the test chamber 10. The operating temperature of the thermal storage may be in a range of from about 75° C. to about 210° C. In various aspects, the thermal storage 203 may lower the temperature of the second working fluid entering the thermal storage 203. For example, the thermal storage 203 may lower the temperature of the second working fluid entering the thermal storage 203 by 2° C. or more, preferably 10° C. or more.

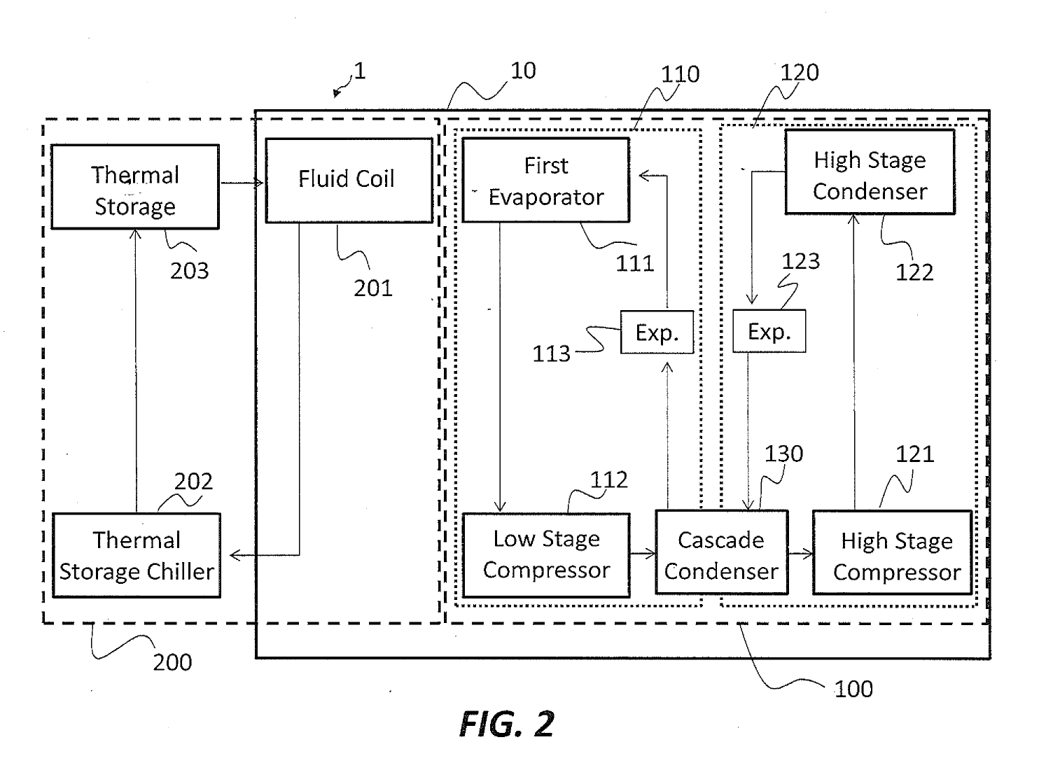

FIG. 2 depicts a schematic diagram showing an exemplary thermal system 1 including a test chamber 10 according to the disclosure. The test chamber 10 may include a first cooling system 100 with a cascade condenser 130. The test chamber 10 may be further connected to a second cooling system 200.

The first cooling system 100 may include a low stage loop 110, a high stage loop 120 and a cascade condenser 130. The low stage loop 110 may process a low stage working fluid. The low stage loop 110 may include a low stage compressor 112 and a first cooling load evaporator 111. The low stage loop 110 may be connected to the cascade condenser 130.

The low stage working fluid may be a refrigerant. In one aspect, the low stage working fluid may be any suitable working fluid for a particular application of the system such as flammability, toxicity, or the like. In some aspects, the low stage working fluid may include fluoride. In various aspects, the low stage working fluid may include fluoroolefiris.

The low stage loop 110 may optionally include a low stage expansion device 113. The low stage expansion device 113 may substantially reduce the pressure and the temperature of the low stage working fluid that may circulate through the low stage loop 110. The low stage working fluid exiting the low stage expansion device 113 may circulate to the first cooling load evaporator 111.

In the first cooling load evaporator 111, the low stage working fluid may be evaporated to form a low stage working vapor by absorbing heat from the ambient air while traveling through the first cooling load evaporator 111.

The low stage working vapor exiting the first cooling load evaporator 111 may enter the low stage compressor 112. The compression of the low stage working vapor may be through a single compressor. Alternatively, one or more compressors may be employed in the thermal system 1. Compressors may virtually include any type of compressor capable of capacity and pressure control, such as oil-flooded screw compressors, reciprocating or centrifugal compressors.

The low stage compressor 112 may compress the low stage working vapor, thereby increasing the pressure and the temperature of the low stage working vapor. The compressed low stage working vapor may exit the low stage compressor 112 and then circulate to the cascade condenser 130.

In the cascade condenser 130, the low stage working vapor may be condensed and liquefied when heat is removed, and may completely or in part return to the fluid form. The low stage working fluid may circulate through the cascade condenser 130 and further to the low stage expansion device 113.

The cascade condenser 130 may be further connected to the high stage loop 120. The high stage loop 120 may process a high stage working fluid. The high stage working fluid may include a refrigerant. In one aspect, the high stage working fluid may be any suitable working fluid for a particular application of the system, such as flammability, toxicity, or the like. In some aspects, the high stage working fluid may include fluoride. In various aspects, the high stage working fluid may include fluoroolefins.

The high stage loop 120 may include a high stage compressor 121 and a high stage condenser 122. While circulating through cascade condenser 130, the high stage working fluid may be evaporated by absorbing heat from the low stage working vapor being liquefied and may form a high stage working vapor. The high stage working vapor may circulate through the cascade condenser 130 and further to the high stage compressor 121.

The high stage compressor 121 may compress the high stage working vapor, thereby increasing the pressure and the temperature of the high stage working vapor. The compressed high stage working vapor may circulate to the high stage condenser 122.

In the high stage condenser 122, the high stage working vapor may be condensed and liquefied. The high stage working fluid exiting the high stage condenser 122 may optionally circulate to the high stage expansion device 123 that may substantially reduce the pressure and the temperature of the high stage working fluid. The high stage working fluid exiting the high stage expansion device 123 may circulate to the cascade condenser 130.

The cooling rate of the test chamber having the first cooling system may depend on the capacity of the cooling systems in the thermal system I. In one aspect, the cooling rate of the first cooling system 100 may be 1° C./min or higher. For example, the cooling rate of the first cooling system 100 may be in a range of from about 1.4° C./min to about 4.5° C./min. The test chamber 10 may be operated in a temperature range of from about −73° C. to about 200° C. The test chamber 10 may be configured to control Relative Humidity. For example, the test chamber 10 may be operated in a humidity range of from about 10% RH to about 90% RH. The first cooling system may have power in various ranges. In one aspect, the first cooling system may have power of 1 HP or higher. In some aspects, the first cooling system may have power in a range of from about 1 HP to about 5 HP. In various aspects, the first cooling system may have 2 HP.

The test chamber may be further connected to the second cooling system 200. The second cooling system may have power of 1 HP or higher. In some aspects, the second cooling system may have power in a range of from about 1 HP to about 5 HP. In various aspects, the second cooling system may have 2 HP. Optionally, the power of the second cooling system may be equal to or less than the power of the first cooling system.

The second cooling system 200 may include a fluid coil 201, a thermal storage 203, and a thermal storage chiller 202. In one aspect, the thermal storage 203 may be placed outside the test chamber 10. In some aspects, the thermal storage 203 and the thermal storage chiller 202 may be placed outside the test chamber 10. In various aspects, the fluid coil 201 may be placed inside the test chamber 10.

The second working fluid may be a refrigerant. In one aspect, the second working fluid may be any suitable working fluid for a particular application of the system such as flammability, toxicity, or the like. In some aspects, the second working fluid may include fluoride. In various aspects, the second working fluid may include fluoroolefins.

In one aspect, the fluid coil 201 may be placed inside the test chamber 10. The second working fluid from the thermal storage 203 may enter the fluid coil 201. The temperature of the second working fluid may increase by absorbing heat from the ambient air while traveling through the fluid coil 201. The heated second working fluid or vapor may circulate to the thermal storage chiller 202.

In one aspect, the thermal storage chiller 202 may be placed outside the test chamber 10. The second working fluid may be condensed and cooled and/or liquefied while traveling through the thermal storage chiller 202.

The cooled second working fluid exiting the thermal storage chiller 202 may enter the thermal storage 203. In one aspect, the thermal storage 203 may be placed outside the test chamber 10. The operating temperature of the thermal storage may be in a range of from about −75° C. to about 210° C. In various aspects, the thermal storage 203 may lower the temperature of the second working fluid entering the thermal storage 203. For example, the thermal storage 203 may lower the temperature of the second working fluid entering the thermal storage 203 by 10° C. or more.

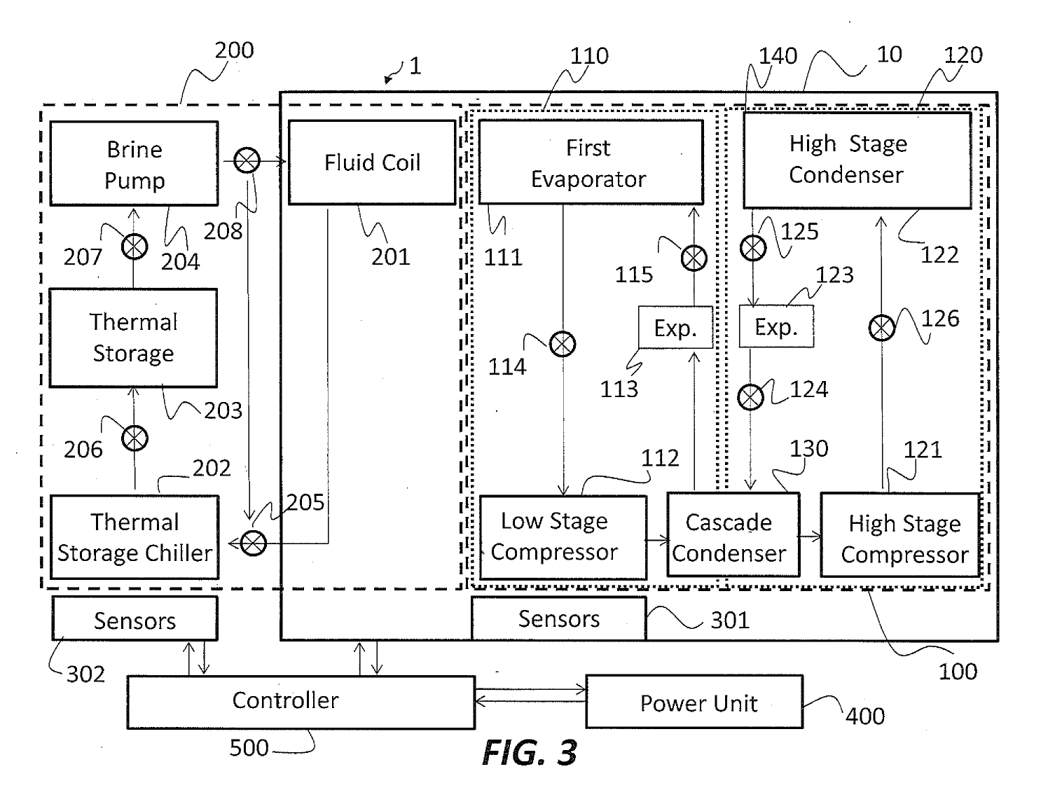

FIG. 3 depicts a schematic diagram showing another exemplary thermal system 1 including the test chamber 10 according to the disclosure. Similar to the thermal system 1 described in FIG. 2, the test chamber 10 may include the first cooling system 100 with the cascade condenser 130. The test chamber 10 may be further connected to the second cooling system 200. The first cooling system 100 may include the low stage loop 110 and the high stage loop 120. Subsequently, the low stage loop 110 may include the first cooling load evaporator 111, the low stage compressor 112, and the low stage expansion device 113. The low stage loop 110 may be connected to the cascade condenser 130.

In one aspect, the low stage loop 110 may have one or more valves such as valves 114, 115 placed in various locations in the low stage loop 110. The valves may adjust the amounts of low stage working fluid or vapor circulating through the low stage loop 110.

The high stage loop 120 may have one or more valves such as valves 124, 125, 126 placed in various locations in the high stage loop 120. The valves may adjust the amounts of high stage working fluid or vapor circulating through the high stage loop 120.

The second cooling system 200 may include a pump 204 to circulate the second working fluid in the second cooling system 200. In one aspect, the pump 204 may be placed outside the test chamber 10. The second working fluid exiting the second thermal storage 203 may enter the pump 204. The second working fluid exiting the pump 204 may enter the fluid coil 201. Optionally, the pump 204 may include a brine pump. Alternatively, there may be a bypass between the brine pump 204 and the fluid coil 201 so that the second working fluid exiting the brine pump 204 may enter the thermal storage chiller 202 when the test chamber 10 does not need additional cooling from the second cooling system 200.

In one aspect, the test chamber 10 may include one or more cooling load evaporators. In some aspects, the test chamber may include at least one cooling load evaporator from the first cooling system and at least one from the second cooling system. The test chamber 10 including such a plurality of cooling systems may achieve a cooling rate of 10.0° C./min or higher.

The thermal system 1 may include a controller 500. The controller 500 may control temperature and/or other operating conditions of the thermal system 1 so that the temperature of the test chamber 10 can remain in a determined range. The thermal system 1 may further include one more of temperature sensors 301, 302 and a power unit 400. The controller 500; and the sensors 301, 302 may be connected to the first cooling system 100 and the second cooling system 200.

One or more of sensors such as sensors 301, 302 may be placed in various locations such as the test chamber 10, and the cooling systems 100, 200. The sensors 301, 302 may monitor the temperatures and/or operating conditions of the designated places and communicate the obtained temperature and/or operating conditions to the controller 500. The power unit 400 may deliver power to the test chamber 10 and any affiliated units thereof such as the first cooling system 100, the second cooling system 200 and the controller 500. Operation of the power unit 400 may be in turn controlled by the controller 500.

The controller 500 may include a general purpose computer or specialty computer or programmable circuit board or other circuitry. In one aspect, the controller 500 may include a processor which may be a computer including a central processing unit (CPU), an application specific integrated circuit (ASIC), a microprocessor, microcontroller, a field programmable gate array (FPGA), complex programmable logic device (CPLD), or other suitable processor or processing device, with associated memory or programming, for controlling the operation of test chamber and any affiliated units thereof. The controller 500 may be connected to and control the valves, 114, 115, 124, 125, 126, 205, 206, 207, 208 of the cooling systems

Within the controller 500, the individual control signals from the sensors 301, 302 are used to determine/calculate optimal process threshold values. Such threshold values may be used to specify bypass, speed, slide valve position and the like. In one aspect, the threshold values may be used to adjust the quantity of stored working fluid and the operating temperature and pressure of the cooling systems 100, 200 and those of the test chamber 10. In some aspects, the test chamber 10 may be cooled only with the first cooling system 100 placed within the test chamber 10. Based upon information received from one or more sensors 301, 302, the controller 500 at operation may determine, or calculate the optimal threshold values of the test chamber 10. If the test chamber 10 does not achieve the optimal threshold values, for example, such as a target temperature and a target cooling rate, only with the first cooling system, the controller 500 may activate the second cooling system 200 during the operation of the first cooling system 100.

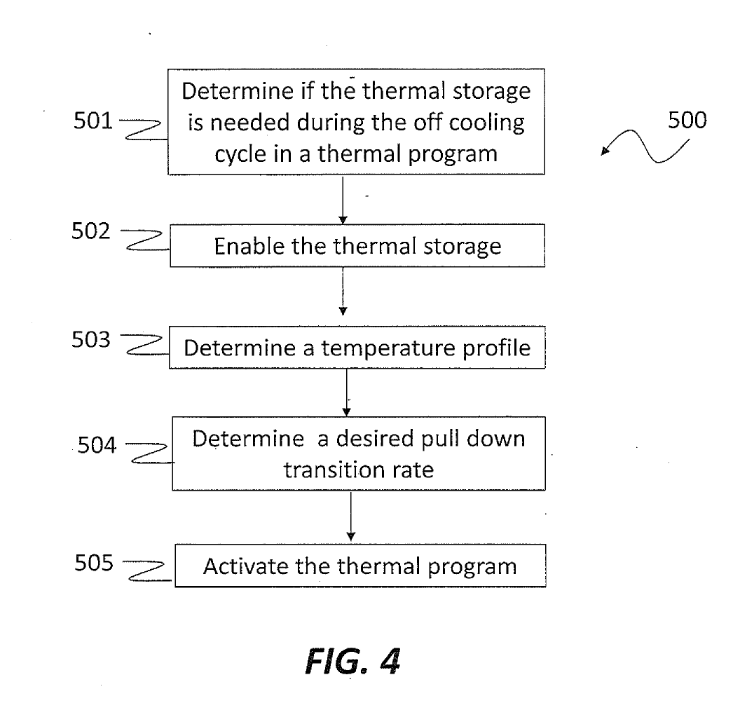

FIG. 4 depicts a schematic chart showing exemplary operation steps of the controller 500. In step 501, the controller 500 may determine if the thermal storage 203 is needed during the off cooling cycle and proceed to step 502 to enable the thermal storage 203 if necessary. In one aspect, the thermal storage 203 may be enabled in a thermal program where a temperature profile including heating and soaking is long enough for the thermal storage 203 to store a desired cooling capacity (step 503). In some aspects, the thermal storage 203 may be enabled when the thermal program requires a fast temperature pull down rate (step 504). For example, the controller 500 may be configured to allow the thermal storage 203 to reach the peak storage capacity and pull down the temperature as fast as possible using the first cooling load evaporator 111 and the fluid coil 201. Subsequently, the controller 500 may activate the thermal program (step 505).

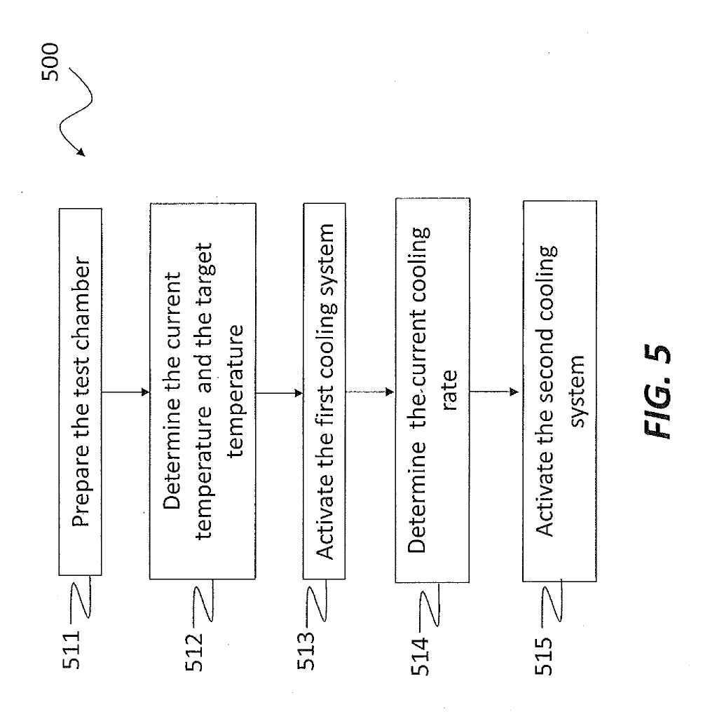

FIG. 5 depicts another schematic chart showing exemplary operation steps of the controller 500. In step 511, the controller 500 may check the test chamber 10 and proceed to step 512 to determine the current temperature and the target temperature. Subsequently, the controller 500 may proceed to step 513 to activate the first cooling system 100, The controller 500 may further determine the current cooling rate of the test chamber 10 while operating the first cooling system 100 as in step 514. When the current cooling rate \dot{T} of the test chamber 10 is below \dot{T}c where \dot{T}c is a threshold cooling rate as shown below,

\dot{T}<\dot{T}c (2)

the controller 500 may activate the second cooling system 200 as in step 515 while operating the first cooling system 100.

The controller 500 may adjust valve positions, speed, or guide vanes to achieve the optimal threshold values. For example, based on the operating temperature and the operating cooling rate, the controller 500 may proportion one or more of the valves 114, 115, 124, 125, 126, 205, 206, 207, 208 connected to the cooling systems on each cooling cycle to achieve a desired temperature or cooling rate in the test chamber 10. The valves 114, 115, 124, 125, 126, 205, 206, 207, 208 may be of several types including but not limited to thermo-static valves and electrically driven control valves. Optionally, the valves 114, 115, 124, 125, 126, 205, 206, 207, 208 may be equipped with local control logic.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

We claim:

1. A system, comprising:
a chamber;
a first cooling system comprising a first cooling load evaporator, wherein the first cooling system is placed within the chamber;
a second cooling system comprising a fluid coil, wherein the fluid coil is placed within the chamber; and
a thermal storage for a second working fluid in the second cooling system, wherein the thermal storage is placed outside the chamber.

2. The system according to claim 1, wherein the first cooling system further comprises a first compressor and a first condenser, and wherein the second cooling system further comprises a thermal storage chiller, wherein the thermal storage chiller is placed outside the chamber.

3. The system according to claim 1, wherein the first cooling system comprises a single compressor.

4. The system according to claim 1, wherein the first cooling system further comprises:
a low stage loop;
a high stage loop; and
a cascade condenser.

5. The system according to claim 4, wherein the low stage loop is configured to process a low stage working fluid, wherein the high stage loop is configured to process a high stage working fluid, and wherein the low stage loop and the high stage loop are connected to the cascade condenser.

6. The system according to claim 4, wherein the system is configured to process the low stage working fluid, the high stage working fluid, and the second working fluid separately from each other within the system.

7. The system according to claim 4, wherein the low stage loop further comprises:
a low stage compressor; and
the first cooling load evaporator, and
wherein the high stage loop further comprises:
a high stage condenser; and
a high stage compressor.

8. The system according to claim 1, further comprising one or more valves, wherein the valves are configured to adjust an amount of the second working fluid flowing into the fluid coil in the second cooling system.

9. The system according to claim 5, further comprising one or more valves, wherein the valves are configured to adjust amounts of the low stage working fluid, the high stage working fluid and the second working fluid flowing in the system, respectively.

10. The system according to claim 1, wherein power of the second cooling system is equal to or less than power of the first cooling system.

11. The system according to claim 1, wherein the second cooling system further comprises a brine pump.

12. The system according to claim 1, further comprising one or more expansion devices.

13. The system according to claim 1, further comprising a controller configured to control the first cooling system and the second cooling system.

14. The system according to claim 13, wherein the controller is configured to activate the second cooling system when the first cooling system is being operated at full capacity.

15. The system according to claim 13, wherein the controller is further configured to activate the second cooling system when a cooling rate of the chamber is less than a target cooling rate.

16. A method for manufacturing a system, comprising:
preparing a first cooling system comprising a low stage loop, a high stage loop, and a cascade condenser;
placing the first cooling system inside a test chamber;
connecting the low stage loop to the cascade condenser;
connecting the high state loop to the cascade condenser;
preparing a second cooling system comprising a fluid coil, a thermal storage to store a second working fluid, and a thermal storage chiller;
placing the fluid coil inside the test chamber;
placing the thermal storage outside the test chamber; and
placing the thermal storage chiller outside the test chamber.

17. The method according claim 16, further comprising
configuring the second cooling system to process the second working fluid in the second cooling system separate from the first cooling system.

18. The method according to claim 16, further comprising
connecting a controller to the first cooling system,
connecting the controller to the second cooling system,
configuring the controller to activate the second cooling system when a cooling rate of the test chamber is less than a target cooling rate.

19. The method according to claim 18, further comprising
preparing a low stage working fluid for the low stage loop;
preparing a high stage working fluid for the high stage loop; and
configuring the first cooling system to separately flow the low stage working fluid and the high stage working fluid from the second working fluid.

20. An apparatus, comprising
a chamber;
means for evaporating a first cooling medium, wherein the means for evaporating the first cooling medium is placed inside the chamber;
means for evaporating a second cooling medium, wherein the means for evaporating the second cooling medium is placed inside the chamber; and
means for storing the second cooling medium, wherein the means for storing the second cooling medium is placed outside the chamber,
wherein the second cooling medium separately flows from the first cooling medium within the apparatus.
